(19) United States
(12) Patent Application Publication
(10) Pub. No.: US 2005/0029306 A1
(43) Pub. Date: Feb. 10, 2005

(54) Dispensing cartridge with tortuous vent path

(76) Inventor: Robert Charles Brennan, Bordentown, NJ (US)

Correspondence Address: PATENT ADMINSTRATOR;KATTEN MUCHIN ZAVIS ROSENMAN, 525 WEST MONROE STREET, SUITE 1600, CHICAGO, IL, 60661-3693, US

(21) Appl. No.: 10/860,976

(22) Filed: Jun. 4, 2004

(30) Foreign Application Priority Data
Dec. 6, 2002 (WO) PCT/US02/39041

(51) Int. Cl. G01F 11/06

(52) U.S. Cl. 222/327

(57) ABSTRACT

A dispensing cartridge for a relatively precise dispensing of various fluids having a relatively wide range of viscosities is disclosed. The dispensing cartridge in accordance with the present invention is relatively simpler in configuration than known dispensing cartridges while minimizing leakage of the fluid and eliminating problems associated with chemical attack of the O-ring by the fluid in the dispensing cylinder. In particular, the dispensing cartridge in accordance with the present invention includes a cylinder; a piston with a central bore and a bleed plug. In order to simplify the design, the air vent is configured as a tortuous path, for example, a spiral path, defined by a spiral bleed plug, which in a pre-staged position, allows air to freely escape along the spiral path along the circumference of the plug. As the piston contacts the fluid, the forward motion of piston is resisted by the high back pressure created by the small effective diameter and relatively long length of the spiral path. Once the piston contacts the fluid, the spiral plug is pushed into the piston closing the spiral path. By controlling the fluid flow by way of a tortuous path, the amount of fluid backflow through the piston is minimized if not eliminated, thus eliminating the need for an annular overflow chamber, thereby simplifying the design of the piston. In order to minimize problems related to the sealing of the piston within the dispensing cartridge, the piston may be provided with one or more radially extending sealing lips. These sealing lips are used in lieu of or in conjunction with an O-ring. The sealing lips further simplify the design by eliminating the O-ring as well as the need for an annular chamber adjacent thereto as well as problems relating to chemical attack of the O-ring by the fluid within the dispensing cylinder. In an alternative embodiment for use that is particularly adapted with non-aggressive fluids, the piston is provided with a single sealing lip and an O-ring.

### BACKGROUND OF THE INVENTION

1. Field of the Invention

The present invention relates to a dispensing cartridge for relatively precise dispensing of various fluids having a relatively wide range of viscosities, the cartridge including a cylinder, a piston with a central bore and a bleed plug, the central bore and bleed plug configured to provide a tortuous path to prevent backflow of the fluid under normal operating conditions, thereby eliminating the need for an overflow chamber. The piston is further configured with one or more annular sealing lips for sealing the piston within the cylinder, thereby eliminating the need for an O-ring forming a single seal configuration. Alternatively, for use, inter alia, with non-aggressive fluids, the piston may be configured with one or more sealing lips and an O-ring forming a multiple seal configuration.

2. Description of the Prior Art

Dispensing cartridges for relatively precise dispensing of fluids are known in the art. Examples of such dispensing cartridges are disclosed in U.S. Pat. Nos. 4,951,848; 5,178,305 and 5,400,926. Such dispensing cartridges are known to include a cylinder with a nozzle, a piston, sealed within the cylinder by way of an O-ring, and a plug. The piston is configured with an axial air vent in order to bleed air as the piston is moved toward the fluid surface. The plug closes the axial air vent once the piston contacts the fluid surface in order to prevent leakage of the fluid through the axial air vent. In order to accommodate fluids with relatively high viscosities, which may have irregular static surface profiles, the fluid contacting surface of the piston is configured with a concave profile with a number of radially extending slots or channels in communication with the axial air vent, for example, as disclosed in U.S. Pat. No. 4,951,848. As such, as the piston initially encounters the fluid surface profile, trapped air is channeled by way of the radial slots to the axial air vent to release any trapped air. Once the piston is in contact with the fluid, the plug is used to close the axial air vent to prevent leakage of the fluid to provide relatively precise dispensing of the fluid as the piston is moved downward further in the dispensing cylinder.

In order to prevent leakage of the fluid through the axial air vent while the piston is being moved downward in the dispensing cylinder, U.S. Pat. No. 5,178,305 discloses a dispensing cartridge in which the piston is provided with an annular overflow chamber in fluid communication with the axial air vent. As such, as the piston is moved toward the fluid surface, any fluid backflowing through the axial air vent is captured in the annular overflow chamber. When such a cartridge is used with fluids having medium or relatively low viscosities, the axial air vent allows relatively free flow of the fluid therethrough as the piston is displaced downwardly. As such, in order to prevent leakage of the fluid outside the cartridge, the overflow chamber and the plug are configured such that the annular overflow chamber is closed by the plug along with the axial air vent. Unfortunately, such a configuration complicates the configuration of the device making it relatively more difficult to fabricate.

Another problem encountered by such known dispensing cartridges relates to the use of an O-ring for sealing the piston within the dispensing cylinder. In particular, it is known that O-rings may become chemically unstable due to chemical attack by the fluid within the dispensing cylinder. In order to solve this problem, U.S. Pat. No. 5,400,926 discloses the use of one or more annular sealing lips, integrally formed on the outside surface of the piston. One of the sealing lips is configured to create an annular chamber between the O-ring and sealing lip for collecting fluids as the piston is moved downward to prevent migration of the fluid (particularly low viscosity fluids) from coming into contact with the O-ring. In order to create the annular chamber between the one or more sealing lips and the O-ring, one of the sealing lips is formed with an annular shoulder or base portion having a relatively larger diameter than the other sealing lip. Such a configuration further complicates the design of the dispensing cartridge making it relatively more difficult to manufacture. Thus, there is a need for a dispensing cartridge that is relatively less complicated than known dispensing cartridges and also addresses the issues discussed above regarding preventing chemical attack of the O-ring and preventing leakage of the fluid after the piston is in contact with the fluid in the dispensing cylinder.

### SUMMARY OF THE INVENTION

Briefly, the present invention relates to a dispensing cartridge for relatively precise dispensing of various fluids having a relatively wide range of viscosities. The dispensing cartridge in accordance with the present invention is relatively simpler in configuration than known dispensing cartridges while minimizing leakage of the fluid and eliminating problems associated with chemical attack of the O-ring by the fluid in the dispensing cylinder. In particular, the dispensing cartridge in accordance with the present invention includes a cylinder, a piston with a central bore and a bleed plug. In order to simplify the design, the combination of the air vent and bleed plug are configured to form a tortuous path, for example, a spiral path, which, in a pre-staged position, allows air to freely escape along the spiral path along the circumference of the plug. As the piston contacts the fluid, the forward motion of piston is resisted by the high back pressure created by the small effective diameter and relatively long length of the spiral path. Once the piston contacts the fluid, the bleed plug is pushed into the piston closing the spiral path. By controlling the fluid flow by way of a tortuous path, the amount of fluid backflow through the piston is minimized if not eliminated, thus eliminating the need for an annular overflow chamber, thereby simplifying the design of the piston. In order to minimize problems related to the sealing of the piston within the dispensing cartridge, the piston may be provided with one or more radially extending sealing lips. These sealing lips are used in lieu of or in conjunction with an O-ring. The sealing lips further simplify the design by eliminating the O-ring as well as the need for an annular chamber adjacent thereto as well as problems relating to chemical attack of the O-ring by the fluid within the dispensing cylinder. In an alternative embodiment for use, for example, with non-aggressive fluids, the piston is provided with a single sealing lip and an O-ring.

### DESCRIPTION OF THE DRAWING

These and other advantages of the present invention will be readily understood with reference to the following specification and attached drawing wherein:

FIG. 1 is a sectional view of the dispensing cartridge in accordance with the present invention, shown carrying a fluid with an irregular surface profile and with the piston spaced away from the fluid surface.

FIG. 2 is similar to FIG. 1, but shown with the piston in contact with the fluid surface and the plug in a pre-staging position.

FIG. 3 is similar to FIG. 2, but shown with the plug in a closed position.

FIG. 4 is a partially exploded view illustrating the plug in a pre-staging position.

FIG. 5 is a sectional view of an alternative embodiment of the piston for use with the present invention, shown with the bleed plug in an open or pre-staging position.

FIG. 6 is similar to FIG. 5, but shown with the bleed plug in a closed position.

FIG. 7 is a perspective view of the piston illustrated in FIG. 5.

FIG. 8 is similar to FIG. 7, but shown with the bleed plug in a closed position.

FIG. 9 is a bottom view of the piston illustrated in FIGS. 5-8.

FIG. 10 is a perspective view of an alternate embodiment of a single lip multiple seal piston for use with the present invention.

FIG. 11 is a bottom plan view of the piston illustrated in FIG. 10.

FIG. 12 is a top plan view of the piston illustrated in FIG. 10.

FIG. 13 is a sectional view of the piston along line 13-13 of FIG. 12.

FIG. 14 is a sectional view of the piston along line 14-14 of FIG. 12.

FIG. 15 is a perspective view of an alternate embodiment of a single seal multiple lip piston in accordance with the present invention.

FIG. 16 is a bottom plan view of the piston illustrated in FIG. 15

FIG. 17 is a top plan view of the piston illustrated in FIG. 15.

FIG. 18 is a sectional view of the piston along line 18-18 of FIG. 17.

FIG. 19 is a sectional view of the piston along line 19-19 of FIG. 17.

### DETAILED DESCRIPTION

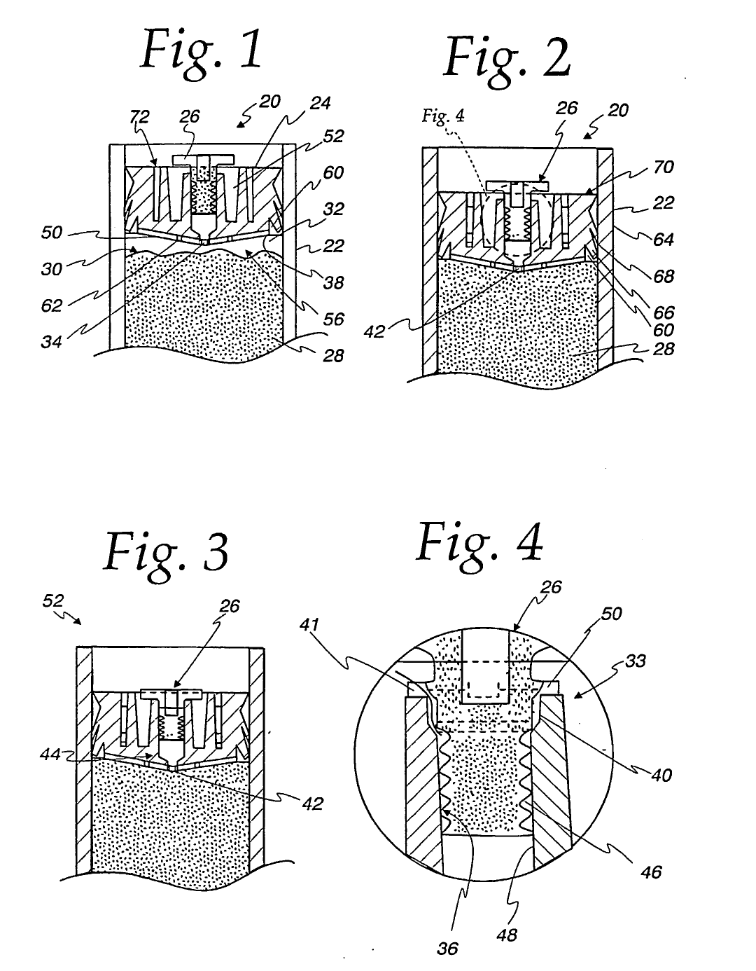

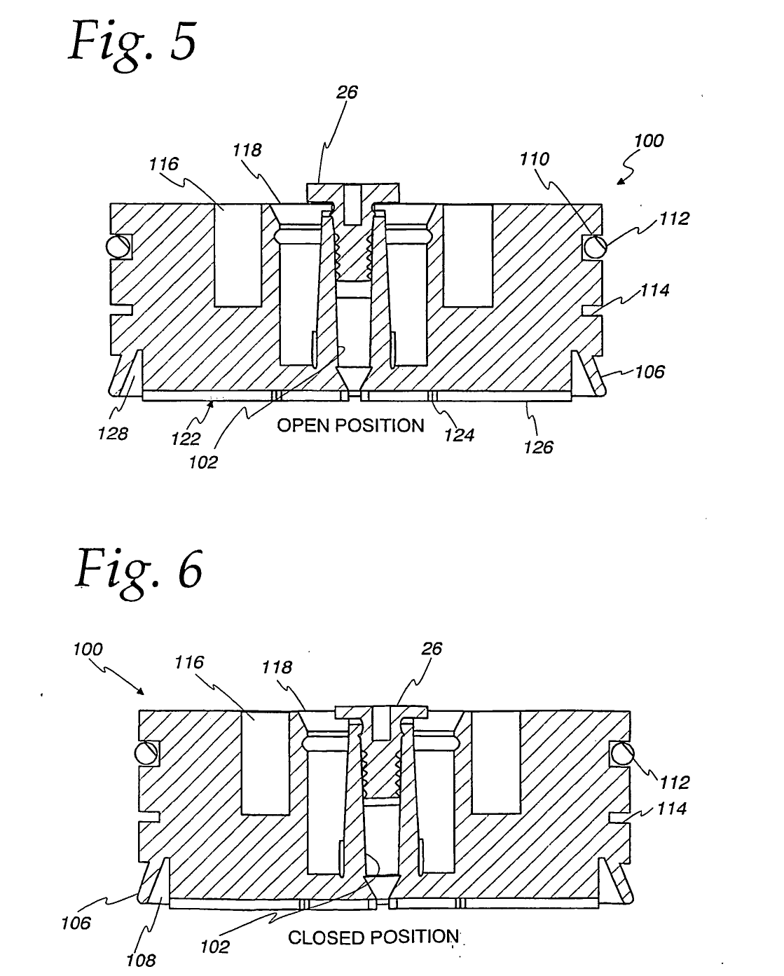

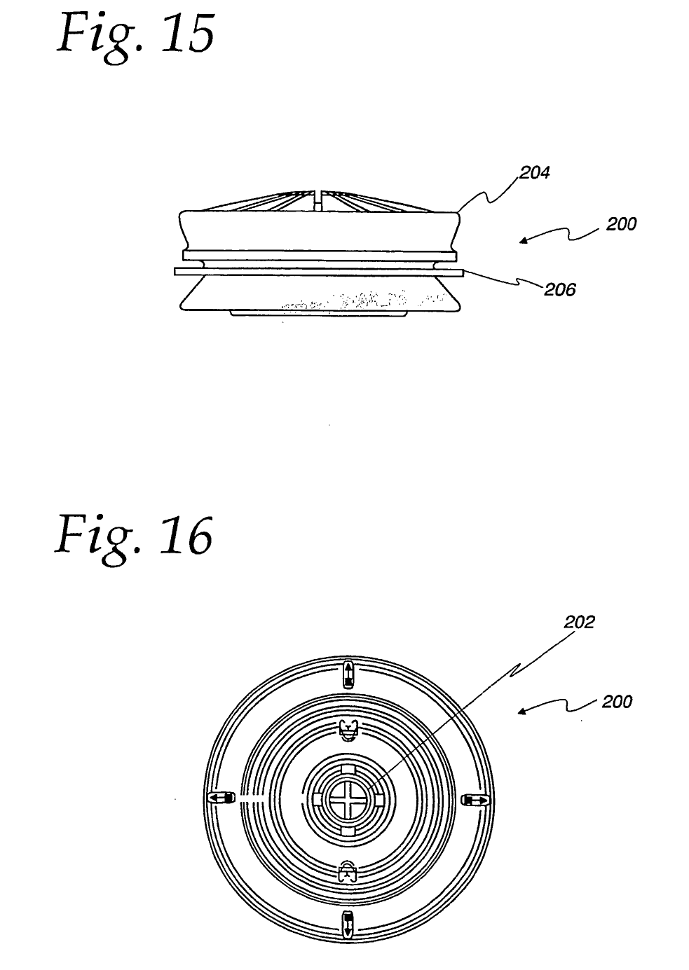

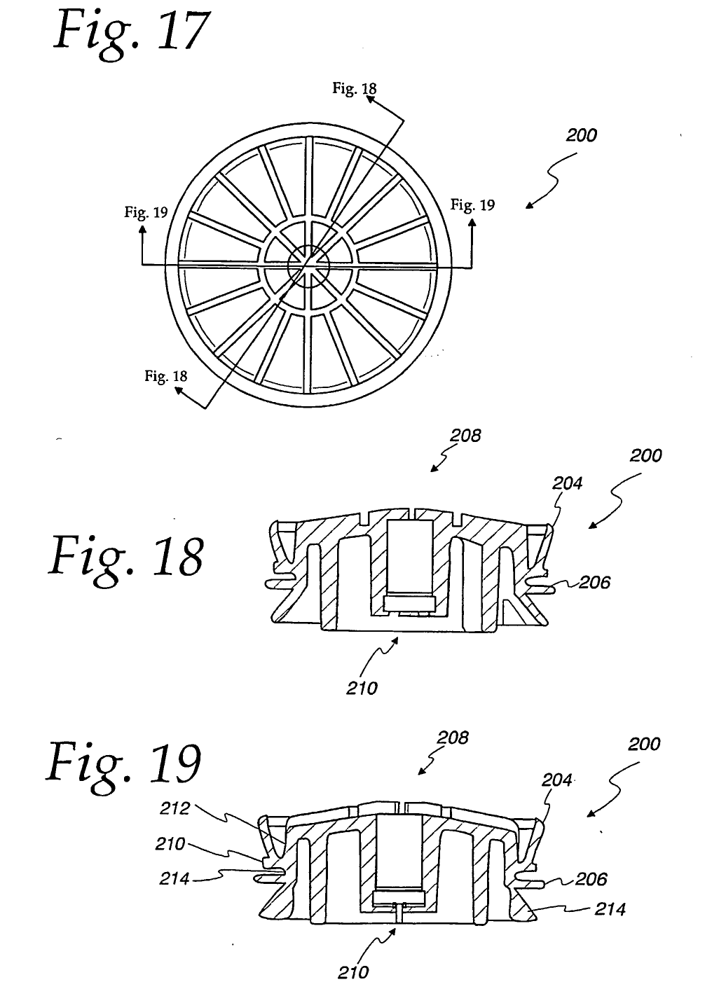

The present invention relates to a dispensing cartridge for relatively precise dispensing of fluids, for example, high viscosity fluids, such as caulking compounds. The dispensing cartridge includes a cylinder, a piston and a bleed plug. As will be discussed in more detail below, an air vent is provided in the piston and a bleed plug together form a tortuous path, for example, a spiral path, which allows air to freely escape but requires relatively high pressure (i.e. higher than normal operating pressure) in order for the fluid to backflow through the path, thus eliminating the need for an overflow chamber. In one embodiment of the invention, as illustrated in FIGS. 1-4, the piston is provided with the one or more sealing lips in lieu of an O-ring in order to further simplify the design, as well as totally eliminate known problems related to sealing the piston within the dispensing cartridge. By eliminating the O-ring, known problems associated with chemical attack of the O-ring by certain fluids within the dispensing cylinder are totally eliminated. In an alternative embodiment of the invention, as shown in FIGS. 5-9, the piston is configured with a single sealing lip and includes an O-ring particularly adapted for use with non-aggressive fluids. FIGS. 10-14 illustrate an alternate embodiment of the piston for use with the present invention configured with a single lip and an O-ring which forms a multiple seal. FIGS. 15-19 illustrate another embodiment of the piston for use with the present invention configured with a single seal formed from multiple lips.

### Embodiment Illustrated in FIGS. 1-4

Referring to FIG. 1 the dispensing cartridge, generally identified with the reference numeral 20, includes a dispensing cylinder 22, a piston 24 and bleed plug 26. The dispensing cylinder 22 includes a bottom surface and a nozzle (not shown) for dispensing the fluid under the influence of the piston 24.

The dispensing cartridge 20 may be utilized with fluids with a relatively wide range of viscosities, collectively referred to with the reference numeral 28. As shown in FIG. 1, the dispensing cylinder 22 is filled with a fluid 28 having a relatively high viscosity, such as a caulking compound, which results in an irregular static fluid surface profile 30. For fluids 28 with relatively lower viscosities, the fluid surface profile 30 will be generally flat. The dispensing cartridge 20 in accordance with the present invention is configured to be used with fluids with a generally flat surface profile as well as irregular surface profiles, as generally illustrated in FIG. 1.

In order to provide relatively precise dispensing of the fluid 28 from the dispensing cylinder 22, any air in the ullage space 32 between the piston 24 and the fluid surface 30 must be evacuated. In accordance with an important aspect of the invention, the piston 24 and bleed plug 26 are configured to provide a controlled evacuation of the air in the ullage space 32, while at the same time preventing backflow of the fluid 28 through the piston 24. More particularly, the piston 24, is formed as a cylindrical member, formed from a dimensionally stable and chemically inert material, such as a thermoplastic or thermoset material. The piston 24 is formed with a central bore 34 that is closed by the bleed plug 26. The bleed plug 26 and the central bore 34 are configured to provide a tortuous vent path. As shown best in FIG. 4, the bleed plug 26 may be formed with an exemplary threaded stud portion 36 that defines a spiral path.

The threaded stud portion 36 is adapted to be received in the central bore 34 of the piston 24. The top portion 38 of the central bore 34 is formed with an increased inner diameter portion, defining an annular shoulder 40.

Other configurations of a tortuous path are also contemplated. For example, the central bore may be configured with a helical groove and the bleed plug formed with a cylindrical cross section.

In a pre-staging position (i.e. the position as shown in FIGS. 2 and 4), the configuration of the bleed plug 26 and the top portion 38 of the central bore 34 define a path to the atmosphere for air being vented through the tortuous path, generally indicated by the arrow 41. In order to further control the air flow through the dispensing piston 24, a reduced diameter inlet 42 is provided on a bottom end 44 of the central bore 34. Accordingly, when the bleed plug 26 is in a pre-staging position as shown in FIGS. 2 and 4, a controlled or tortuous vent path is created between the inlet 42 and the spiral cavity, generally identified with the reference numeral 46, defined between the bleed plug 26 and the inner wall 48 of the central bore 34. In order to close the bleed plug 26 within the central bore 34, the bleed plug 26 may be formed with an annular angled rib portion 50. The rib portion 50 is configured to seat against the annular shoulder 40, formed at the top of the central bore 34 and close the spiral air cavity 46. Thus, when the bleed plug 26 is fully seated, for example, as shown in FIG. 3, the tortuous path 41 is closed. By providing a tortuous path 41, air in the ullage space 32 is easily and quickly evacuated as the piston 26 is moved toward the surface 30 of the fluid 28. As the piston 24 reaches the fluid surface profile 30, the tortuous path 41 restricts backflow of the fluid under normal operating conditions, thus obviating the need for an overflow chamber.

In order to further facilitate evacuation of any air in the ullage space 32, the bottom portion 54 (FIG. 1) of the piston 24 may be formed in a generally convex shape with a plurality of radial slots or channels 56. Each radial slot 56 is formed with a uniform depth to simplify the device. The radial slots 56 are configured such that one end of each of the radial slots 56 is in fluid communication with inlet 42 of the central bore 34. The opposing end 58 of each of the radial slots 56 is in fluid communication with an annular wedge-shaped slot 60. In order to further facilitate air evacuation of the ullage space 32, one or more circular slots 62 may be provided on the bottom surface 54 of the dispensing piston 24.

In order to seal the piston within the dispensing cylinder 22, one or more annular sealing lips 64 and 66 are provided. These sealing lips 64 and 66 may be integrally formed with the dispensing piston 24 and configured to prevent migration of the fluid 28 past the upper sealing lip 64 in order to provide relatively precise dispensing of the fluid 28. The sealing lips 64 and 66 are provided in lieu of an O-ring, thus eliminating problems associated with chemical attack of the O-ring by the fluid 28.

As shown in FIG. 2, for example, the sealing lips 64 and 66 face downwardly and define the wedge-shaped annular cavity 60 and another annular cavity 68. As mentioned above, the annular cavity 60 is in fluid communication with the radial channels 56, which, in turn, are in fluid communication with the inlet 42 of the central bore 34. Thus, as the bottom convex surface 54 of the piston 24 contacts the fluid surface profile 30, any air trapped in the annular wedge-shaped chamber 60 is directed through the radial channels 56 and to the inlet 42 of the central bore 34. Any migration of the fluid 28 past the sealing lips 66, for example, in applications of relatively low viscosity fluids, is collected in the wedge-shaped chamber 68, defined between the sealing lips 66 and 68.

Unlike known dispensing cartridges, the dispensing cartridge 20 does not utilize an O-ring seal. By eliminating the need for an O-ring, the problem related to chemical attack of the O-ring by the fluid 28 is totally eliminated. In addition, unlike known prior art dispensing cartridges, as discussed above, the need to form an additional chamber between the upper sealing lip 64 and the O-ring is also eliminated, thus further simplifying the design.

Annular cavities 52 and 72 (FIG. 1) may be formed in the piston 24. The annular cavities 52 and 72 form annular ribs and are used, depending on the diameter of the piston 24, to increase its rigidity.

In operation, the dispensing cylinder 22 is filled with a fluid 28, for example, a relatively high viscosity fluid, such as a caulking compound, having an irregular surface profile 30, as generally shown in FIG. 1. The bleed plug 26 is initially partially inserted or pre-staged in the central bore 34 of the piston 24 as shown in FIG. 4. The dispensing piston 24 is then inserted into the dispensing cylinder 22. In an initial position as shown in FIGS. 1, 2 and 4, the bleed plug 26 is disposed within the central bore 34 to define the tortuous vent path 41, as shown best in FIG. 4. As the dispensing piston 24 is moved toward the fluid surface profile 30 (FIG. 1), air in the ullage space 32 is easily evacuated by way of the vent path 41. As the piston 24 comes in contact with the fluid 28, continued downward motion of the piston 24 is impeded by relatively high back pressure created by the small effective diameter and relatively long length of the tortuous path 46. Any air trapped between the bottom surface 54 of the piston 24, the annular wedge shaped chamber 60, and the fluid surface profile 30 is evacuated by way of the channels 54, which are in fluid communication with the inlet 42 of the central bore 34 and the tortuous spiral path 46, created by the bleed plug 26. Further downward movement of the bleed plug 26 causes it to seat against the annular shoulder 40 defined by the interior annular sidewall of the central bore 34 to close the tortuous path 41.

### Embodiment Illustrated in FIGS. 5-9

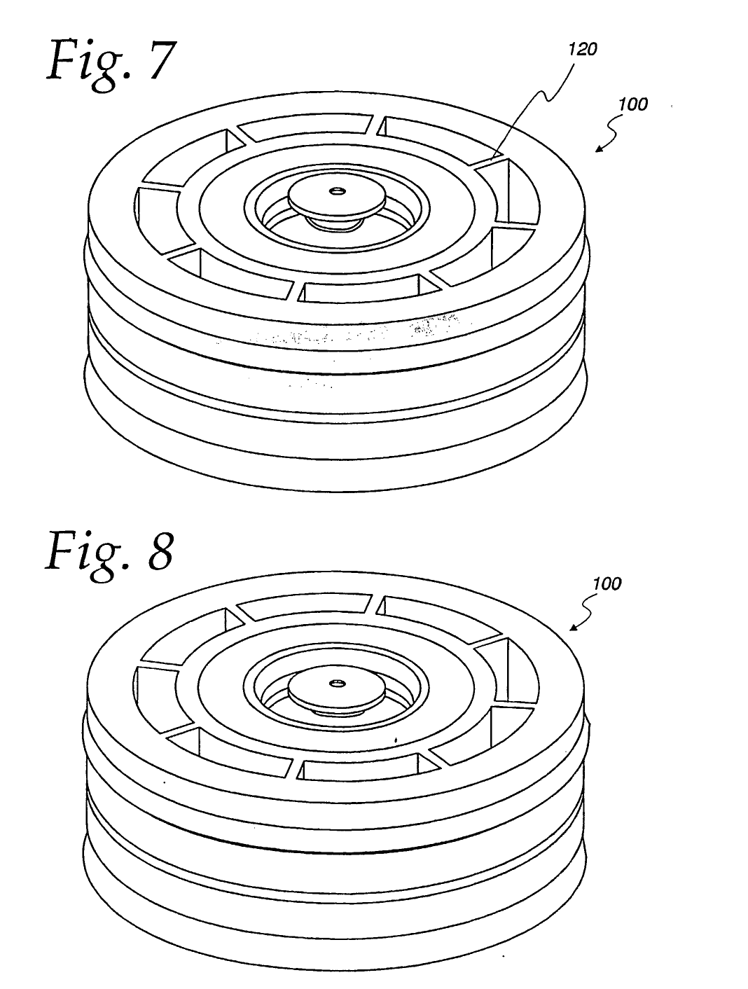

FIGS. 5-8 illustrate an alternate embodiment of the invention particularly adapted for use with non-aggressive fluids. In this embodiment, as will be discussed in more detail below, a single sealing lip and an O-ring is used to seal the piston 100 within the dispensing cylinder 22. The piston 100 is configured to receive the bleed plug 26 which provides a tortuous vent path in an open position, as illustrated in FIGS. 5 and 7. When the bleed plug 26 is in a closed position, as illustrated in FIGS. 6 and 8, the vent path is closed. Similar to the embodiment in FIGS. 1 and 4, the use of the tortuous vent path eliminates the need for an overflow chamber.

Referring first to FIGS. 5 and 6, the piston 100 is formed as a cylindrical member, for example, from a dimensionally stable and chemically inert material, such as a thermoplastic or thermal set material. The piston 100 includes a central bore 102 for receiving the bleed plug 26, as discussed above.

In the embodiment of the invention illustrated in FIGS. 5-8, a single annular sealing lip 106 is formed adjacent one end of the piston 100. The sealing lip 106 may be integrally formed with the piston 100, defining a wedge-shaped annular slot 108.

In order to further seal the piston 100 within the dispensing cylinder 22, an annular groove 110 is formed along the outer periphery of the piston 100. The annular groove 110 is configured to receive an O-ring 112. The O-ring 112 and sealing lip 106 seals the piston 100 within the dispensing cylinder 24.

A second annular groove 114 may be provided along the outer periphery of the piston 100, disposed between the annular groove 110 and the sealing lip 106. The annular groove 114 is optional and may be used to catch any of the fluid that migrates past the sealing lip 106.

The piston 100 as well as the piston 24 (FIGS. 1-4) is configured to be molded by conventional molding techniques, such as injection molding. In accordance with conventional injection molding techniques, the interior portion of the piston 24 and 100 may be formed with various configurations. For example, as illustrated in FIGS. 5 and 6, the piston 100 may be formed with two concentric annular slots 116 and 118. These slots 116 and 118 may be formed with various axial lengths, as shown in FIGS. 5 and 6. As shown in FIGS. 7 and 8, the outer slot 116 may be partitioned with a number of radial ribs 120. As shown best in FIGS. 7 and 8, the inner annular slot 118 may be continuous or partitioned by radial ribs (not shown) to provide additional rigidity of the piston 100, as shown.

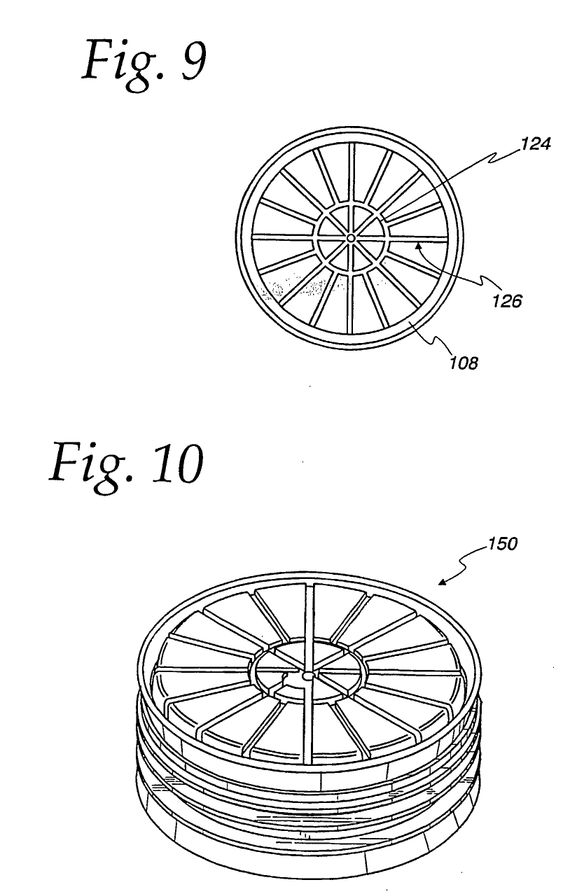

In accordance with another aspect of the invention, the bottom surface 122 of the piston 100 may be formed as a flat surface as illustrated in FIG. 5 or 6, or optionally with a convex surface as illustrated in FIGS. 1-3. As best shown in FIG. 9, the bottom surface 122 may be formed with one or more circular grooves 124 in fluid communication with various radial slots, generally identified with the reference numeral 126, which, in turn, are in fluid communication with the wedge-shape annular slot 108 and the central bore or vent 102. The configuration of the bottom surface 122 facilitates evacuation of air from the ullage space between the bottom surface 122 of the piston 100 and the fluid surface.

### Embodiment Illustrated in FIGS. 10-14

FIGS. 10-14 illustrate another alternate embodiment of a piston, for use with present invention, generally identified with the reference numeral 150. Similar to the embodiment illustrated in FIGS. 5-8, the piston 150 illustrated in FIGS. 10-14 is for use with relatively low viscosity non-aggressive fluids. As will be discussed in more detail below, the piston 150 is configured with one or more lips and is further configured to receive an O-ring to form a multiple seal type device.

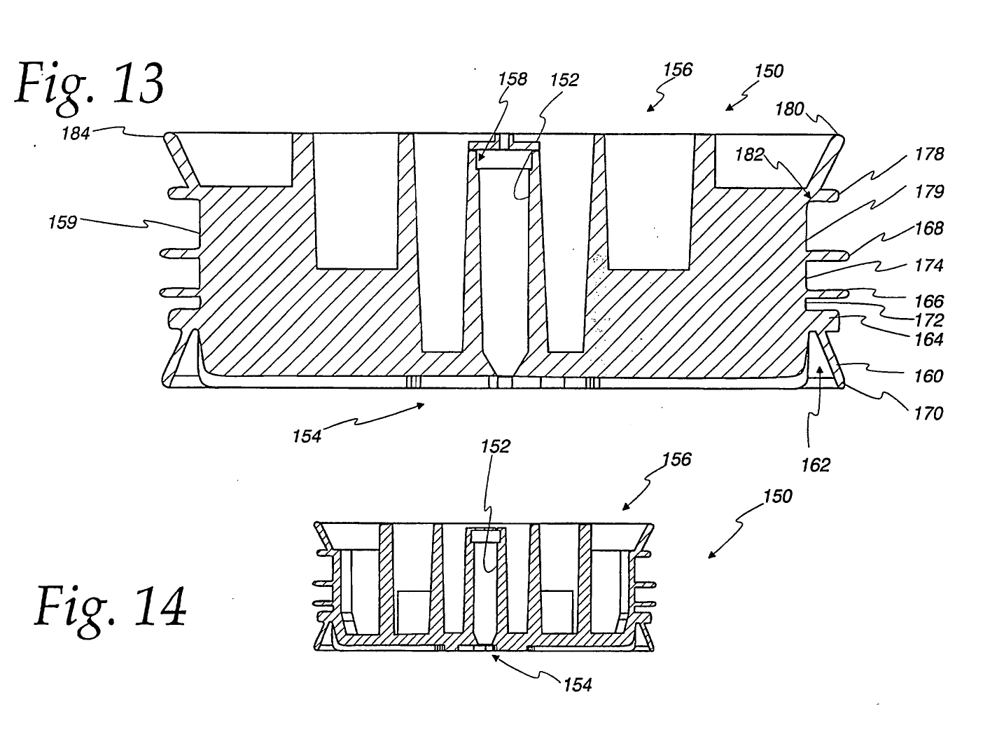

The piston 150 is configured to receive a bleed plug, similar to the bleed plug 26, shown, for example, in FIGS. 5 and 6. More particularly, as shown best in FIGS. 13 and 14, the piston 150 includes a vent path 152 for receiving a bleed plug and providing a tortuous vent path as discussed above.

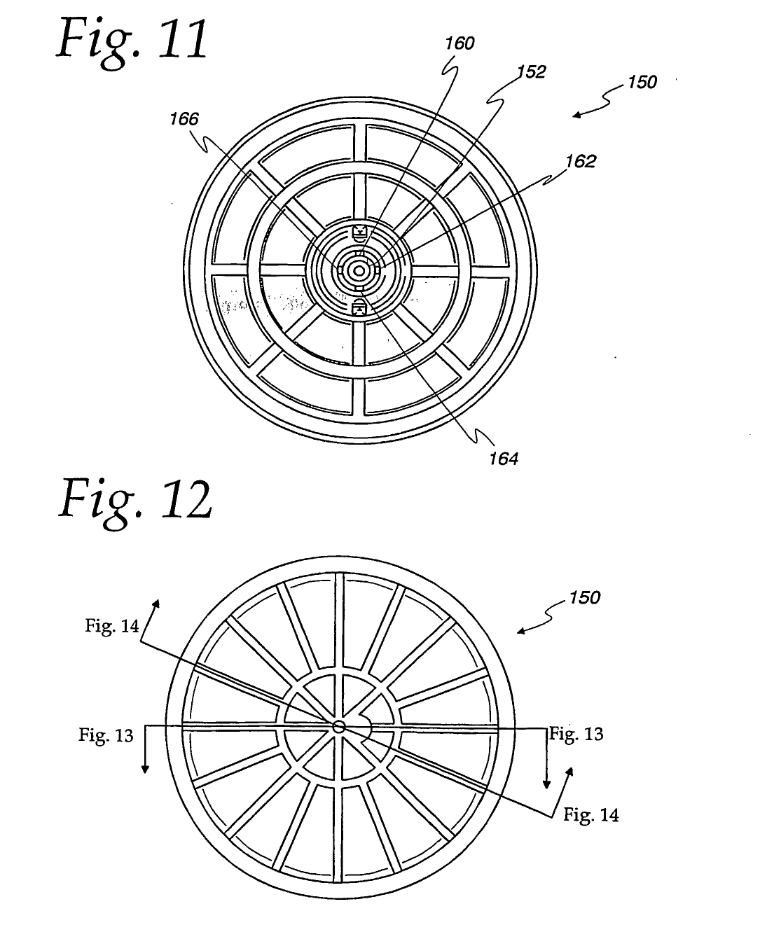

For brevity, only the differences between piston 150 and the piston 100 illustrated in FIGS. 5-8 are described below. Firstly, as best shown in FIGS. 11-13, the vent path 152, is cylindrical, in shape, open on a fluid contacting end 154 as well as an opposing end 156. As shown best in FIG. 13, the top portion of the vent path is formed with an increased diameter portion 158. A plurality of axial notches 160, 162, 164 and 166 are formed in the increased diameter portion 158 of the vent path 152. The axial slots 160, 162, 164 and 166 as well as the increased diameter portion 158 facilitate placement of the bleed plug into the vent path 152.

Another difference between the piston 150 and the piston 100, illustrated in FIGS. 5-8 relates to the configuration of the outer peripheral surface 159 of the piston 150. In particular, referring to FIG. 13, for example, the piston 150 is formed with a one or more annular sealing lips 160. The annular sealing lip 160 is formed at an acute angle 162 relative to the plane of the outer peripheral surface 159 of the piston 150. More particular, an angular flange 164 is spaced away from the non-fluid contacting end 154 of the piston 150. The annular sealing lip 162 extends outwardly from an intermediate position on the annular flange 164 to the fluid contacting end 154 of the piston 150.

Two annular walls 166 and 168 are formed axially spaced apart from each other and spaced away from the annular flange 164. The annular walls 166 and 168 extend radially outwardly from the outer peripheral surface 159 of the piston 150 to a distance substantially aligned in a radial direction with the furthest extending point 170 of the lower annular lip 160. The extending annular walls 166 and 168 define two annular cavities 172 and 174 when the piston is disposed within a cylinder, for example, as shown in FIGS. 1-3.

As shown, the radius of the annular flange 164 is less than the radius of the annular wall 166 as well as the radius of the furthest extending point 170 of the lower annular lip 160. With such a configuration, any portion of the fluid which migrates past the annular lip 162 will be trapped in the annular space 172.

An annular shoulder 178 along the peripheral surface 159 is formed at a position spaced away from the non-fluid contacting end 156 of the piston 150. An annular cavity 179 is formed between the annular shoulder 178 and the annular wall 168. The annular cavity 179 is for receiving an O-ring, like the O-ring 112 (FIGS. 5 and 6) forming a multiple seal piston (i.e. lip plus O-ring).

The annular cavity 174 provides extra protection for the O-ring by providing a second annular cavity between the lower annular lip 160 on the fluid contacting end 154 of the piston 150 and the O-ring within the annular cavity 179. With such a configuration, any fluid which migrates past the lower annular lip 160 is trapped in the annular cavity 172. Should the annular cavity 172 fill up and/or any fluid migrate past the annular wall 166, it will be caught in the annular cavity 174, thus providing increased protection against fluid contacting the O-ring.

An alignment lip 180 is formed on the non-fluid contacting end 156 of the piston 150. The alignment lip 180 extends from a base portion 182 of annular flange 178 to a point 184 having the same radius as the radius of the point 170 of the lower lip 170. The upper lip 180 is angled in a direction opposite to that of the lower lip 160 as shown, for example, in FIG. 12. The alignment lip 180 provides for axial alignment of the piston 150 within the cylinder.

Lastly, the fluid contacting end of the piston 150 is formed with a relatively flat surface as best shown in FIGS. 13 and 14 like the embodiment illustrated in FIGS. 5 and 6 but unlike the embodiment illustrated in FIGS. 1-3.

### Embodiment Illustrated in FIGS. 15-19

FIGS. 15-19 illustrates another embodiment of a piston for use with the present invention, generally identified with the reference numeral 200. The piston 200 is configured for use with relatively aggressive fluids and utilizes multiple sealing lips and does not incorporate an O-ring for sealing the piston 200 in the cylinder.

As shown best in FIG. 16, the vent cavity 202 is formed in a similar manner as the vent cavity 158 (FIG. 11) of the piston 150. As such this aspect will not be discussed further.

The piston 200, however, incorporates multiple sealing lips 204 and 206 (FIGS. 15, 18 and 19). The sealing lip 204 is disposed adjacent a fluid contacting end 208 (FIG. 19) of the piston 200. An annular flange 210 is formed at an axial position spaced away from the fluid contacting end 208 of the piston 200. The sealing lip 204 extends outwardly from an intermediate position along the annular flange 210. The second sealing lip 206 is formed as an annular wall at an axial position spaced away from the annular flange 210 forming an annular cavity 214 therebetween when the piston 200 is displaced within a cylinder. The annular cavity 214 is used to catch fluid that migrate past the sealing lip 204.

An annular angled wall 214 is formed adjacent the non-fluid contacting end 210 of the piston 200. The angled wall 214 provides axial stability of the piston 200 within a cylinder.

Similar to the embodiment illustrated in FIGS. 1-3 but unlike the embodiments illustrated in FIGS. 5-14, the fluid contacting end 208 of the piston 200 is formed in a concave shape. The concave shape is best shown in FIGS. 15, 18 and 19.

Obviously, many modifications and variations of the present invention are possible in light of the above teachings. Thus, it is to be understood that, within the scope of the appended claims, the invention may be practiced otherwise than as specifically described above.

1. A dispensing cartridge for dispensing various fluids having a relatively wide range of viscosities, the dispensing cartridge comprising:
a dispensing cylinder;
a piston mounted in said dispensing cylinder, said piston configured with a central bore forming a vent path, said piston defining a fluid contacting surface and a non-contacting fluid surface; and
a bleed plug for closing said central bore, said bleed plug and said central bore configured to define a tortuous vent path.

2. The dispensing cartridge as recited in claim 1, wherein said bleed plug is formed with a threaded portion.

3. The dispensing cartridge as recited in claim 1, wherein said piston is formed with one or more sealing lips adjacent said fluid contacting surface.

4. The dispensing cartridge as recited in claim 3, wherein said piston is additionally configured to receive an O-ring.

5. The dispensing cartridge as recited in claim 1, wherein said fluid contacting surface includes a plurality of radial slots and a wedge shaped annular slot, said radial slots in fluid communication with said wedge shaped annular slot and the central bore.

6. The dispensing cartridge as recited in claim 5, wherein said fluid contacting surface of said piston is generally flat.

7. The dispensing cartridge as recited in claim 5, wherein said fluid contacting surface of said piston is convex.

8. A piston for use is a dispensing cartridge, the piston comprising:
a generally cylindrical shaped member having an axial bore forming a vent path defining a fluid contacting surface and a non-fluid contacting surface and a peripheral outer surface, said peripheral outer surface formed with an annular sealing lip and at least one annular wall.

9. The piston as recited in claim 8, wherein said at least one annular wall forms a second sealing lip.

10. The piston as recited in claim S, wherein an annular cavity is formed intermediate the sealing lip and said non-fluid contacting surface of said piston for receiving an O-ring.

11. The piston as recited in claim 10, wherein said fluid contacting surface is substantially flat.

12. The piston as recited in claim 9, wherein said fluid contacting surface is formed as a convex surface.

13. The piston as recited in claim 8, wherein said piston is formed from a dimensionally stable and chemically inert material.

14. The piston as recited in claim 8, wherein said piston is formed from a thermoplastic material.

15. The piston as recited in claim 8, wherein said piston is formed from a thermoset material.

16. The dispensing cartridge as recited in claim 3, wherein said piston is formed with an alignment lip adjacent said non-contacting fluid surface.

17. The piston as recited in claim 8, wherein said piston is configured with an annular wedge shaped wall adjacent said non-contacting fluid surface.
